(19) United States
(12) Patent Application Publication
(10) Pub. No.: US 2008/0049980 A1
(43) Pub. Date: Feb. 28, 2008

(54) BUTTON WITH INTEGRATED BIOMETRIC SENSOR

(75) Inventors: Julio C. Castaneda, Coral Springs, FL (US); Donald W. Burnette, Sunrise, FL (US); James L. Tracy, Coral Springs, FL (US); Amy M. Tupler, Hollywood, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/467,676

(22) Filed: Aug. 28, 2006

(51) Int. Cl. G06K 9/00

(52) U.S. Cl. 382/115

(57) ABSTRACT

A button assembly (100) that includes a flexible electronic circuit (105) having a first side (110) and a second side (115). The button assembly also can include a biometric sensor (100) mounted to the first side of the flexible electronic circuit. Further, a switch (200) can be positioned at least proximate to the second side of the flexible electronic circuit. A stiffening member (305) can be attached to the first side or the second side of the flexible electronic circuit. The biometric sensor can be operable between a first position and a second position to effectuate opening or closing of the switch. The button assembly can operate the biometric sensor between the first and second positions utilizing pivotal, translational, and/or rotational movement.

### BACKGROUND OF THE INVENTION

1. Field of the Invention

The present invention generally relates to biometric sensors and, more particularly, to biometric sensors which are integrated into buttons.

2. Background of the Invention

The use of mobile stations has grown to an extent that such devices are now ubiquitous throughout most of the industrialized world. Just as their use has grown, so too has the functionality of mobile stations. Indeed, mobile stations now can be used not only for voice communications, but also to perform a number of other tasks. For example, mobile stations can be used to take photographs, capture and stream video, browse the Internet, play games, and send and receive instant messages and e-mail. In consequence, mobile stations often contain sensitive data.

Unfortunately, identity theft has become a serious crime problem worldwide and mobile stations sometimes are targeted for theft in order to obtain personal information. To protect such information, some mobile stations include biometric sensors, such as fingerprint sensors, to confirm identities of users prior to allowing use of a mobile station communication resources and access to information contained on the mobile stations. If a particular user's identity cannot be verified, such access to the resources and information can be denied. If, however, a mobile station is snatched by a thief after a user's identity has already been verified and the mobile station has been left on, the thief may have access to the mobile station's resources and information contained thereon.

One solution to this problem is to integrate the biometric sensor into a button on the mobile station such that the identity of a user is confirmed each time the mobile station is used to communicate or retrieve certain information. Unfortunately, existing biometric sensors are fragile; implementing such sensors into buttons using conventional manufacturing techniques is not suitable for consumer electronic devices.

### SUMMARY OF THE INVENTION

The present invention relates to a button assembly that includes a flexible electronic circuit having a first side and a second side. The button assembly also can include a biometric sensor mounted to the first side of the flexible electronic circuit. Further, a switch can be positioned at least proximate to the second side of the flexible electronic circuit. For example, the switch can be attached to the second side of the flexible electronic circuit. In addition, a stiffening member can be attached to the first side or the second side of the flexible electronic circuit. The button assembly also can include solder pads disposed on the flexible electronic circuit that mount the biometric sensor to the flexible electronic circuit.

The biometric sensor can be operable between a first position and at least a second position to effectuate opening or closing of the switch. The button assembly can include a fulcrum member to which the stiffening member is operatively attached. The fulcrum member can define an axis about which the biometric sensor pivots to operate between the first position and the second position. The button assembly also can include at least one spring member to which the stiffening member is operatively attached, the spring member resiliently biasing the biometric sensor in the first position. The spring member can facilitate translational movement of the biometric sensor between the first position and the second position.

In one arrangement, the stiffening member can include a top member and a rotation member. Further, the button assembly also can include a rotation guide and at least one guide member attached to the rotation member. The guide member can slidably engage the rotation guide to rotate the rotation member about an axis in order to facilitate movement of the biometric sensor between the first position and the second position. The rotation guide can define a groove in which the guide member is slidably engaged. Movement of the biometric sensor can be translational movement.

The button assembly also can include a protective cover disposed over the biometric sensor and the flexible electronic circuit. An opening can be defined in the protective cover to allow the biometric sensor to read fingerprints. In another arrangement, the protective cover can include a window that includes a non-opaque material. The window can allow the biometric sensor to read fingerprints. Further, the button assembly can be positioned between a shell of a device and at least one structure internal to the shell. The protective cover and the shell can form a water-tight seal.

The present invention also relates to a method for assembling a button assembly. The method can include mounting a biometric sensor to a first side of a flexible electronic circuit, positioning a switch at least proximate to a second side of the flexible electronic circuit, and attaching a stiffening member to the first side or the second side of the flexible electronic circuit. Positioning the switch can include attaching the switch to the second side of the flexible electronic circuit. The method also can include attaching a fulcrum member to the stiffening member, the fulcrum member defining an axis about which the biometric sensor pivots to operate between a first position and a second position to effectuate opening or closing of the switch. Further, at least one spring member can be attached to the stiffening member to resiliently bias the biometric sensor in the first position. In one arrangement, the spring member can define a translational movement of the biometric sensor between the first position and the second position.

In another arrangement, attaching the stiffening member can include attaching a top member and a rotation member that together form the stiffening member. In such an arrangement, the method can include attaching at least one guide member to the rotation member. Further, the guide member can be slidably engaged with a rotation guide to facilitate rotation of the rotation member about an axis, thereby facilitating movement of the biometric sensor between a first position and a second position to effectuate opening or closing of the switch.

### BRIEF DESCRIPTION OF THE DRAWINGS

Preferred embodiments of the present invention will be described below in more detail, with reference to the accompanying drawings, in which:

FIG. 1 depicts a perspective view of a biometric sensor mounted to a flexible electronic circuit which is useful for understanding the present invention;

FIG. 2 depicts a perspective view of a switch mounted to the flexible electronic circuit of FIG. 1;

FIG. 3 is an exploded view of an example button assembly that is useful for understanding the present invention;

FIG. 4A is a perspective view of a button sub-assembly that is useful for understanding the present invention;

FIG. 4B is a perspective view of the button sub-assembly of FIG. 4A in a depressed position;

FIG. 5A is a perspective view of another button sub-assembly that is useful for understanding the present invention;

FIG. 5B is a perspective view of the button sub-assembly of FIG. 5A in a depressed position;

FIG. 6A is a perspective view of another button sub-assembly that is useful for understanding the present invention;

FIG. 6B is a perspective view of the button sub-assembly of FIG. 6A in a depressed position;

FIG. 7A is a perspective view of yet another button sub-assembly that is useful for understanding the present invention;

FIG. 7B is a perspective view of the button sub-assembly of FIG. 7A in a depressed position; and

FIG. 8 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a button assembly that includes a biometric sensor and a switch. In particular, the biometric sensor can be mounted to a first side of a flexible electronic circuit, while the switch can be disposed on, or positioned proximate to, a second side of the flexible electronic circuit. The biometric sensor can be operable between a first position and a second position to effectuate opening or closing of the switch. The button assembly can operate the biometric sensor between the first and second positions utilizing pivotal, translational, and/or rotational movement.

A stiffening member can be attached to the first side or the second side of the flexible electronic circuit to add rigidity to the flexible electronic circuit in the region where the biometric sensor is mounted. Use of the stiffening member reduces operational stresses between the biometric sensor and the flexible electronic circuit when the button is depressed, thereby improving durability of the button assembly.

In one arrangement, the button assembly can be implemented as a button of a mobile station, for example as a push-to-talk button or a power on/off button. In another arrangement, the button assembly can be implemented in a wearable electronic device, such as a headset or sunglasses that include electronic components. Still, the button can be implemented on any other electronic apparatus that may process biometric data and the invention is not limited in this regard.

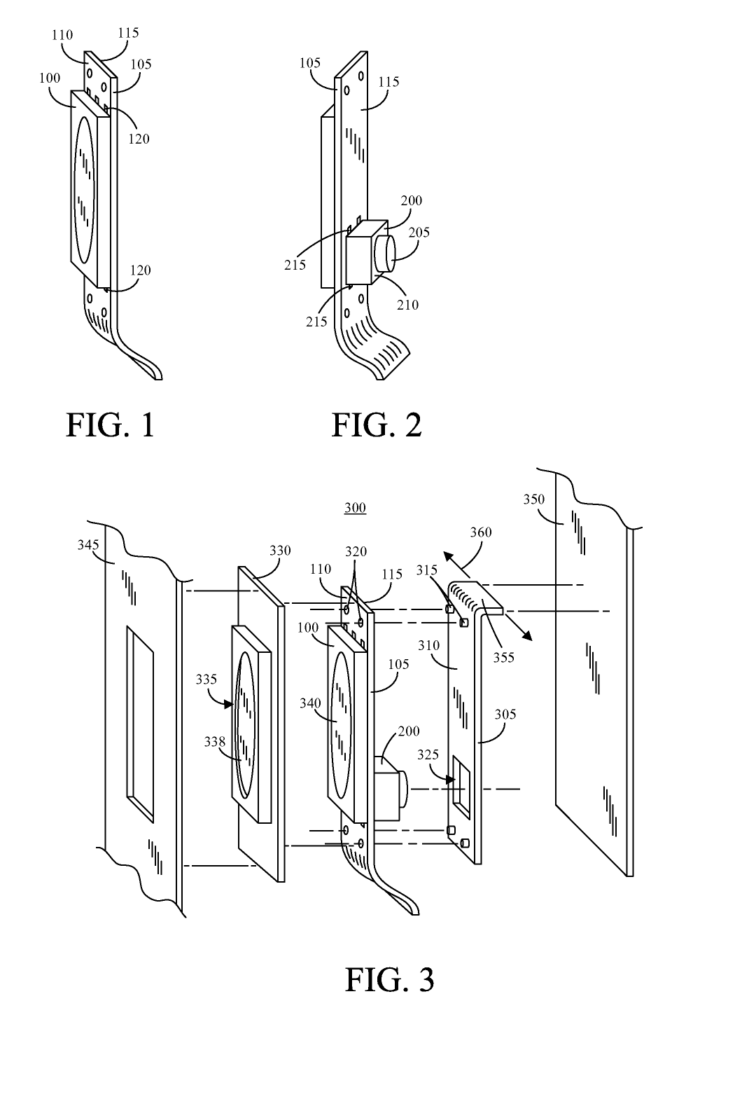

FIG. 1 depicts a perspective view of a biometric sensor 100 mounted to a flexible electronic circuit (hereinafter “flex circuit”) 105. The biometric sensor 100 can be a fingerprint sensor, for instance an image capture device that captures fingerprint images and communicates such images to a suitable image processing application. Examples of suitable fingerprint sensors include, but are not limited to, static capacitive sensors, dynamic capacitive sensors, optic reflexive sensors, optic transmissive sensors with fiber optic plates, acoustic (ultrasound) sensors, pressure sensitive sensors, thermal line sensors, capacitive line sensors, optical line sensors and galvanic sensors. Still, any type of sensor that can capture a fingerprint image and that can be integrated in a button assembly can be used and the invention is not limited in this regard.

The flex circuit 105 can comprise an electronic circuit disposed on, or in, a flexible substrate. Examples of suitable substrates include, but are not limited to, polymers such as polyimide, polyester, polypropylene, polystyrene, polytetraflouroethylene, liquid crystal polymer (LCP), etc. Nonetheless, any electronic circuit substrate that is flexible may be used. The flex circuit 105 can include a first side 110 and a second opposing side 115. The second side 115 can be, for instance, opposing and generally parallel to the first side 110.

The biometric sensor 100 can be mounted to the first side 110 of the flex circuit 105. For example, the flex circuit 105 can include solder pads 120 on the first side 110 to which the biometric sensor 100 attaches, for example via a flow solder process. In another arrangement, the solder pads can be disposed on the second side 115. In such an arrangement, the biometric sensor 110 can include pins that extend through vias in the flex circuit 105 to interface with the solder pads.

FIG. 2 depicts a perspective view of a switch 200 mounted to the flex circuit 105. The switch 200 can include a button 205 which may be depressed to open and/or close the switch 200. The button 205 can be resiliently biased away from a body 210 of the switch, for example using an internal spring member within the switch 200. The switch 200 can be mounted to the second side 115 of the flex circuit 105. For example, the flex circuit 105 can include solder pads 215 to which the switch 200 attaches, for example via a flow solder process. In another arrangement, solder pads can be disposed on the first side 110 of the flex circuit 105, and the switch 200 can include pins that extend through vias in the flex circuit 105 to interface with such solder pads.

FIG. 3 is an exploded view of an example button assembly 300 that is useful for understanding the present invention. In addition to the flex circuit 105, the biometric sensor 100 and the switch 200, the button assembly 300 can include a stiffening member 305. The stiffening member 305 can comprise metal, plastic, or any other rigid or semi-rigid material, and can include a first side 310 configured to attach to the flex circuit 105.

In the example shown, the first side 310 of the stiffening member 305 can have a shape that is generally planar, and the first side 310 of the stiffening member 305 can attach to the second side 115 of the flex circuit 105 which, as noted, also can have a shape that is generally planar. In other arrangements the flex circuit 105 and stiffening member 305 can have other shapes. For instance, the first side 310 of the stiffening member 305 can be convex or concave, and the second side 115 of the flex circuit 105 can form to the shape of the stiffening member 305.

The stiffening member 305 can be attached to the flex circuit 105 in any suitable manner. For example, the stiffening member 305 can be glued to the flex circuit 105. To facilitate positioning of the stiffening member 305 with respect to the flex circuit 105, the stiffening member 305 can include nubs 315 or pins that align with vias 320 within the flex circuit 105. Further, a hole 325 through which the switch 200 can protrude can be defined in the stiffening member 305. In an arrangement in which the stiffening member 305 attaches to the first side 110 of the flex circuit 105, a hole can be defined in the stiffening member 305 through which the biometric sensor 100 can protrude. Alternatively, in lieu of attachment to the flex circuit 105, the switch 200 or the biometric sensor 100 can be attached to the stiffening member 305.

The button assembly 300 also can include a protective cover 330 which may be disposed over the biometric sensor 100 and the flex circuit 105. An opening 335 can be defined in the protective cover 330 to allow the biometric sensor 100 to read fingerprints for appendages that are proximate to an outer surface 340 of the biometric sensor 100. In one arrangement, the protective cover 330 can include a window 338 disposed within the opening. In an arrangement in which the biometric sensor 100 includes an optic device, the window can comprise a non-opaque material, such as a clear plastic or film.

When assembled, the button assembly 300 can be positioned between a shell 345 of a device, such as mobile station, and a structure 350 or structures internal to the shell 345. Further, the protective cover 330 and the shell 345 can be suitably configured to form a water-tight seal. For example, the shell 345 can comprise rubber that is sandwiched between the shell 345 and the flex circuit 105 or the stiffening member 305. Additional water sealant compounds or structures also can be used, and the invention is not limited in this regard. Accordingly, the button assembly 300 can be utilized in a water resistant device.

The flex circuit 105 can be connected to other circuits or components within the device. For instance, a connector (not shown) can be attached to the flex circuit 105 to facilitate mating of the flex circuit 105 to a conventional printed circuit board.

In the example shown, the stiffening member 305 can be operatively attached to a fulcrum member 355, and the fulcrum member 355 can engage the internal structure 350 to define an axis 360 about which the stiffening member 305, and thus the biometric sensor 100, can pivot. The fulcrum member 355 can be secured directly to the stiffening member 305, or secured directly to another component to which the stiffening member 305 is attached. For example, the fulcrum member 355 can be secured to the protective cover 330, which can be secured to the stiffening member 305, thereby providing attachment of the stiffening member 305 to the fulcrum member 355.

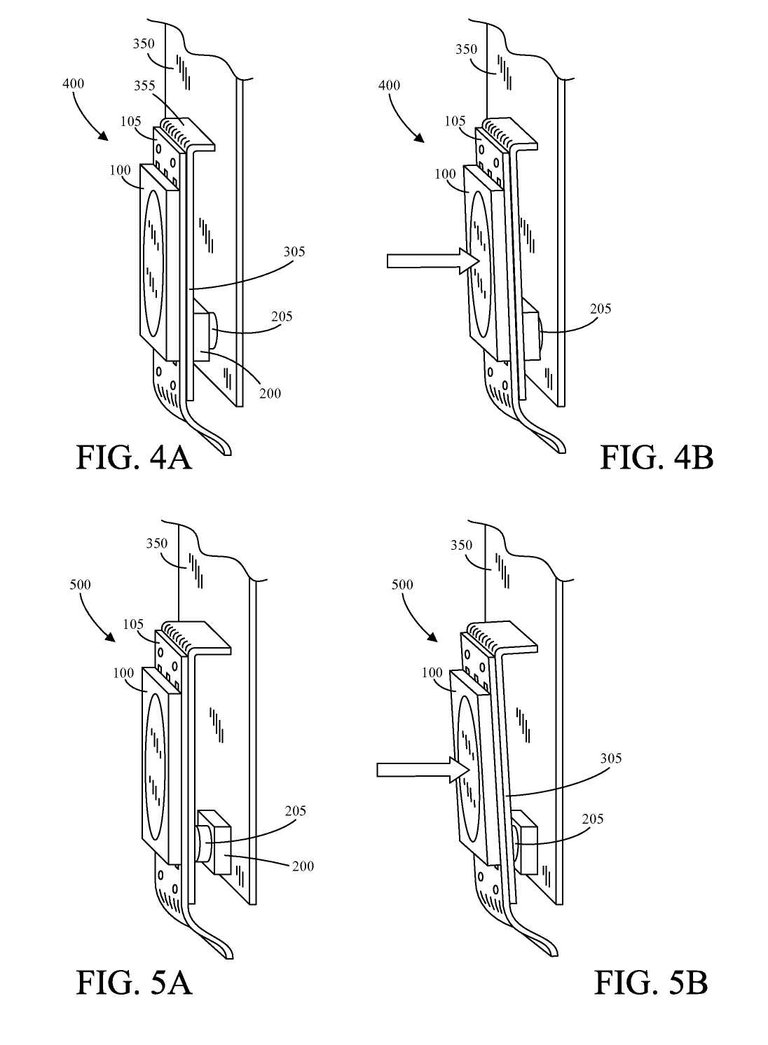

FIG. 4A is a perspective view of a button sub-assembly 400 which is useful for understanding operation of the button assembly 300. The button sub-assembly 400, without the protective cover and the shell, is shown in this view for purposes of clarity. The button sub-assembly 400 can include the biometric sensor 100, the flex circuit 105, the switch 200, the stiffening member 305 and the fulcrum member 355. As noted, the fulcrum member 355 can engage the internal structure 350.

The biometric sensor 100 can be depressed to pivotally operate the button sub-assembly 400 between a first position shown in FIG. 4A, in which the button 205 of the switch 200 is not depressed, to a second position shown in FIG. 4B, in which the switch button 205 is pushed against the internal structure 350 and depressed. The switch button 205 can apply a force to return the button sub-assembly 300 from the second position back to the first position when the depression force applied to the biometric sensor 100 is released. In another arrangement, a spring member (not shown) can resiliently bios the button sub-assembly 300 in the first position.

Advantageously, while the biometric sensor 100 is being depressed by a user, for example using a finger, an image of the user's fingerprint can be captured by the biometric sensor 100 and image data can be generated. The image data then can be communicated via the flex circuit 105 to other device components, for example a datastore or a processor executing user identification software. In one arrangement, depression of the switch button 205 can activate image capture, although the invention is not limited in this regard and image capture can be triggered in any other suitable manner.

FIG. 5A is a perspective view of another button sub-assembly 500 that is useful for understanding the present invention. In comparison to the button sub-assembly 400, the button sub-assembly 500 can be configured such that the switch 200 is not attached to the flex circuit 105, but instead is attached to another device component, such as the internal structure 350. The switch 200 can be attached to the internal structure 350 in any suitable manner. For example, the switch 200 can be snapped or glued to the internal structure 350. The biometric sensor 100 can be depressed to pivotally operate the button sub-assembly 500 between a first position shown in FIG. 5A, in which the switch button 205 is not depressed, to a second position shown in FIG. 5B, in which the stiffening member 305 depresses the switch button 205.

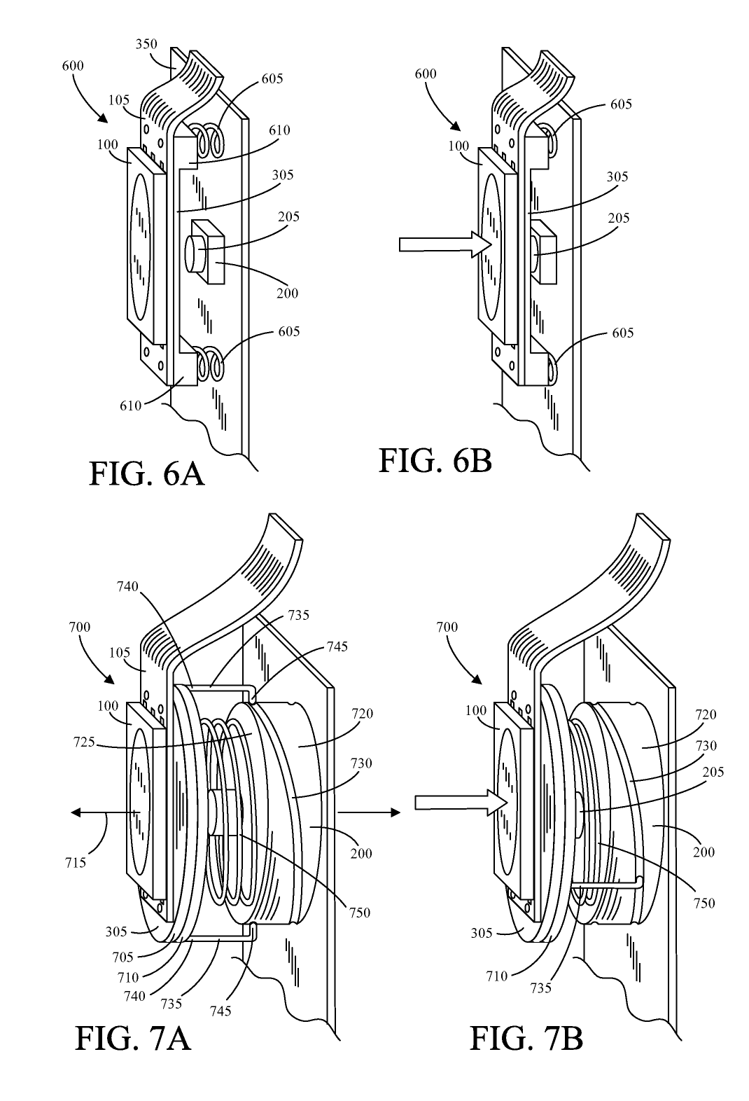

FIG. 6A is a perspective view of another button sub-assembly 600 that is useful for understanding the present invention. The button sub-assembly 600 can include the biometric sensor 100, the flex circuit 105, the switch 200 and the stiffening member 305. The switch 200 can be attached to the internal structure 350, as depicted, or attached to the flex circuit 105 or the stiffening member 305 as previously described. The button sub-assembly 600 also can include spring members 605 that resiliently bios the biometric sensor 100, the flex circuit 105 and the stiffening member 305 into a first position in which the button 205 of the switch 200 is not depressed. In such an arrangement, the stiffening member 305 can include receptacles 610 that engage the springs 605.

Referring to FIG. 6B, the biometric sensor 100 can be depressed to translationally operate the button sub-assembly 600 from the first position to a second position in which the stiffening member 305 depresses the switch button 205. The spring members 605 can apply a translation force to return the button-sub-assembly 600 from the second position back to the first position when the depression force applied to the biometric sensor 100 is released.

FIG. 7A is a perspective view of yet another button sub-assembly 700 that is useful for understanding the present invention. The button sub-assembly 700 can include the biometric sensor 100, the flex circuit 105, the switch 200 and the stiffening member 305. In this arrangement, the stiffening member 305 may comprise a top member 705 and a rotation member 710. The top member 705 and the rotation member 710 can be disk shaped (as depicted), square, rectangular, or any other desired shape. Moreover, the top member 705 and the rotation member 710 each can have a shape that is unique with respect to other button sub-assembly 700 components. The top member 705 can be attached to the rotation member 710 in a manner which allows the rotation member 710 to rotate about an axis 715 while the top member 705 remains aligned in a particular direction. For example, the top member 705 can be secured to the rotation member 710 via a pin or screw (not shown).

The button sub-assembly 700 also can include a rotation guide 720 which, in one arrangement, is an outer shell of the switch 200. In another arrangement, the switch 200 can be disposed within the rotation guide 720 or on an upper surface 725 of the rotation guide 720. One or more grooves 730 can be defined in the rotation guide 720. Further, the button sub-assembly 700 also can include one or more guide members 735. Each of the guide members 735 can include a first end 740 that is attached to the rotation member 710, and a second end 745 that slideably engages at least one of the grooves 730. One or more spring members 750 can resiliently bias the stiffening member 305, and the biometric sensor 100, in a first position, such as the position shown in FIG. 7A.

Referring to FIG. 7B, the biometric sensor 100 can be depressed, thereby depressing the stiffening member 305, which translates the depression force to the guide members 735. Such force can cause the guide members 735 to move along the groves 730 in a manner which causes the rotation member 710 to rotate and compress to a second position in which the stiffening member 305 engages and depresses the button 205 of the switch 200. The spring member 750 can apply a translation force to return the stiffening member 305 from the second position back to the first position shown in FIG. 7A when the depression force applied to the biometric sensor 100 is released.

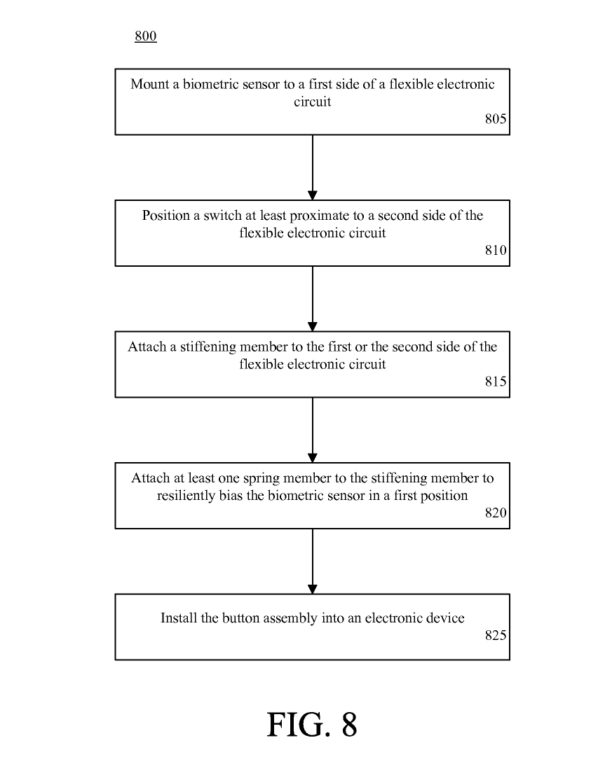

FIG. 8 is a flowchart presenting a method 800 of assembling a button assembly that is useful for understanding the present invention. Referring to step 805, a biometric sensor can be mounted to a first side of a flex circuit. At step 810, a switch can be positioned at least proximate to a second side of the flex circuit. For example, in one arrangement the switch can be attached to the second side. Proceeding to step 815, a stiffening member can be attached to the fist side or the second side of the flex circuit. At step 820, at least one spring member can be attached to the stiffening member to resiliently bias the biometric sensor in a first position, the biometric sensor being operable between the first position and a second position. When the biometric sensor is in the second position, the stiffening member can depress a button on the switch to effectuate opening or closing of the switch. At step 825 the button assembly can be installed into an electronic device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly.

This invention can be embodied in other forms without departing from the spirit or essential attributes thereof. Accordingly, reference should be made to the following claims, rather than to the foregoing specification, as indicating the scope of the invention.

What is claimed is:

1. A button assembly, comprising:
a flexible electronic circuit comprising a first side and a second side;
a biometric sensor mounted to the first side of the flexible electronic circuit;
a switch positioned at least proximate to the second side of the flexible electronic circuit; and
a stiffening member attached to the first side or the second side of the flexible electronic circuit.

2. The button assembly of claim 1, further comprising solder pads disposed on the flexible electronic circuit that mount the biometric sensor to the flexible electronic circuit.

3. The button assembly of claim 1, wherein the switch is attached to the second side of the flexible electronic circuit.

4. The button assembly of claim 1, wherein the biometric sensor is operable between a first position and at least a second position to effectuate opening or closing of the switch.

5. The button assembly of claim 4, further comprising a fulcrum member to which the stiffening member is operatively attached, the fulcrum member defining an axis about which the biometric sensor pivots to operate between the first position and the second position.

6. The button assembly of claim 4, further comprising at least one spring member to which the stiffening member is operatively attached, the spring member resiliently biasing the biometric sensor in the first position.

7. The button assembly of claim 6, wherein the spring member facilitates translational movement of the biometric sensor between the first position and the second position.

8. The button assembly of claim 4:
wherein the stiffening member comprises:
a top member; and
a rotation member;
wherein the button assembly further comprises:
a rotation guide; and
at least one guide member attached to the rotation member, the guide member slidably engaging the rotation guide to rotate the rotation member about an axis in order to facilitate movement of the biometric sensor between the first position and the second position.

9. The button assembly of claim 8, wherein the rotation guide defines a groove in which the guide member is slidably engaged.

10. The button assembly of claim 8, wherein the movement of the biometric sensor is translational movement.

11. The button assembly of claim 1, further comprising a protective cover disposed over the biometric sensor and the flexible electronic circuit.

12. The button assembly of claim 11, wherein an opening is defined in the protective cover to allow the biometric sensor to read fingerprints.

13. The button assembly of claim 11, wherein:
the protective cover comprises a window comprising a non-opaque material, the window allowing the biometric sensor to read fingerprints;
the button assembly is positioned between a shell of a device and at least one structure internal to the shell; and
the protective cover and the shell form a water-tight seal.

14. A button assembly, comprising:
a flexible electronic circuit comprising a first side and a second side;
a biometric sensor mounted to the first side of the flexible electronic circuit;
a switch attached to the second side of the flexible electronic circuit; and
a stiffening member attached to the first side or the second side of the flexible electronic circuit.

15. A method for assembling a button assembly, comprising:
mounting a biometric sensor to a first side of a flexible electronic circuit;
positioning a switch at least proximate to a second side of the flexible electronic circuit; and
attaching a stiffening member to the first side or the second side of the flexible electronic circuit.

16. The method of claim 15, wherein positioning the switch comprises attaching the switch to the second side of the flexible electronic circuit.

17. The method of claim 15, further comprising attaching a fulcrum member to the stiffening member, the fulcrum member defining an axis about which the biometric sensor pivots to operate between a first position and a second position to effectuate opening or closing of the switch.

18. The method of claim 15, further comprising attaching at least one spring member to the stiffening member to resiliently bias the biometric sensor in a first position, the biometric sensor being operable between the first position and a second position to effectuate opening or closing of the switch.

19. The method of claim 15, further comprising attaching at least one spring member to the stiffening member to define a translational movement of the biometric sensor between a first position and a second position to effectuate opening or closing of the switch.

20. The method of claim 15, wherein attaching the stiffening member comprises attaching a top member and a rotation member that together comprise the stiffening member, further comprising:
attaching at least one guide member to the rotation member; and
slidably engaging the guide member with a rotation guide to facilitate rotation of the rotation member about an axis, thereby facilitating movement of the biometric sensor between a first position and a second position to effectuate opening or closing of the switch.
